(19) United States
(12) Patent Application Publication
(10) Pub. No.: US 2011/0069327 A1
(43) Pub. Date: Mar. 24, 2011

(54) METHOD AND APPARATUS FOR FORMING IMAGE

(75) Inventor: Susumu KOIZUMI, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 12/887,445

(22) Filed: Sep. 21, 2010

Related U.S. Application Data
(60) Provisional application No. 61/244,757, filed on Sep. 22, 2009.

(51) Int. Cl. G06K 15/10

(52) U.S. Cl. 358/1.5

(57) ABSTRACT

According to one embodiment, a printer including, an image carrier configured to hold an a first color image and a second color image in a state in which the images overlap each other and configured to move the overlapping the first color image and the second color image to a sheet in a transfer position, and a controller configured to change speed of forming the first color image and the second color image from a first speed to a second speed higher than the first speed when the thickness of the sheet exceeds a threshold, the first speed including speed obtained by correcting fluctuation in the speed due to the thickness of the sheet with respect to the second speed.

### CROSS-REFERENCE TO RELATED APPLICATIONS

This application is based upon and claims the benefit of priority from: U.S. Provisional Application No. 61/244,757 filed on Sep. 22, 2009, the entire contents of each of which are incorporated herein by reference.

### FILED

Embodiments described herein relates generally to an image forming apparatus and a sheet feeding mechanism.

### BACKGROUND

In an image forming apparatus, movement of a sheet that holds an image affects the quality of the image formed by elements that form the image. One of influences on the image quality includes “nonuniformity of image forming speed” caused when the sheet moves while the elements forming the image form the image.

### BRIEF DESCRIPTION OF THE DRAWINGS

A general architecture that implements the various features of the embodiments will now be described with reference to the drawings. The drawings and the associated descriptions are provided to illustrate embodiments and not to limit the scope of the embodiments.

FIG. 1 is an exemplary diagram illustrating an apparatus;

FIG. 2 is an exemplary diagram illustrating a configuration of an imaging section incorporated in the apparatus shown in FIG. 1;

FIG. 3 is an exemplary diagram illustrating a transfer roller at a position for moving a toner image from a transfer belt to a sheet;

FIG. 4 is an exemplary diagram illustrating the transfer roller separated from the transfer belt;

FIG. 5 is an exemplary diagram illustrating a mechanism configured to move a pusher;

FIG. 6 is an exemplary block diagram illustrating a control system of the apparatus;

FIG. 7 is an exemplary diagram illustrating a cam and a pusher in a non-pressed state;

FIG. 8 is an exemplary diagram illustrating a profile of the cam according to FIG. 7;

FIG. 9 is an exemplary diagram illustrating the cam and the pusher in a pressed state;

FIG. 10 is an exemplary diagram illustrating a state in which an outer circumference A section of the cam moves to the pusher;

FIG. 11 is an exemplary diagram illustrating a state in which an outer circumference C section of the cam moves the pusher;

FIG. 12 is an exemplary timing chart illustrating a transfer pressure;

FIG. 13 is an exemplary diagram illustrating a state in which an outer circumference A section of another cam moves the pusher;

FIG. 14 is an exemplary diagram illustrating a state in which an outer circumference B section of another cam moves the pusher;

FIG. 15 is an exemplary diagram illustrating a state in which an outer circumference C section of another cam moves the pusher;

FIGS. 16A, 16B and 16C are exemplary diagrams each illustrating test patterns on the transfer belt and detection examples;

FIG. 17 is an exemplary timing chart illustrating an imaging and sheet moving position;

FIG. 18 is an exemplary diagram illustrating timing of control of the speed of the transfer belt or timing of start of writing of an image; and

FIG. 19 is an exemplary diagram illustrating control of the speed of the transfer belt.

### DETAILED DESCRIPTION

In general, according to an embodiment, a printer comprising: an image carrier configured to hold an a first color image and a second color image in a state in which the images overlap each other and configured to move the overlapping the first color image and the second color image to a sheet in a transfer position; and controller configured to change speed of forming the first color image and the second color image from a first speed to a second speed higher than the first speed when the thickness of the sheet exceeds a threshold, the first speed including speed obtained by correcting fluctuation in the speed due to the thickness of the sheet with respect to the second speed.

Embodiments will now be described hereinafter in detail with reference to the accompanying drawings.

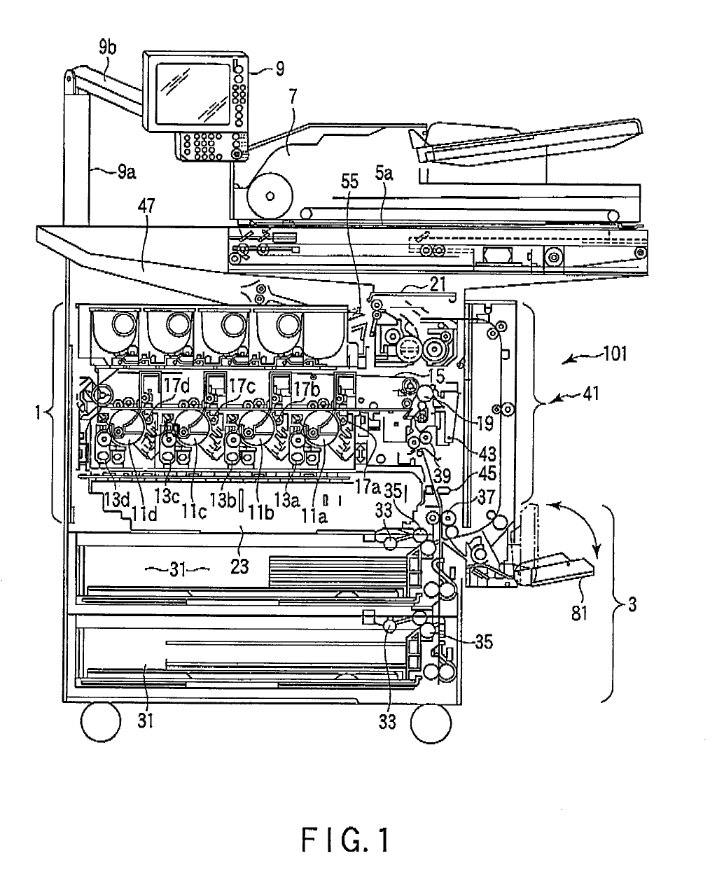

FIG. 1 schematically shows an MFP (Multi-Functional Peripheral) to which the embodiment is able to apply.

An MFP 101 shown in FIG. 1 has an image forming section 1 for outputting image information as an output image which is referred to as a hard copy or a print out, for example, a paper supplying section 3 capable of supplying, to the image forming section 1, paper (an output medium) having an optional size which is used for an image output, and an image reading section 5 for taking, as image data, image information to be an image forming object in the image forming section 1 from an object holding the image information (which will be hereinafter referred to as an original).

The image reading section 5 includes an original table (an original glass) 5a for supporting an object and an image sensor for converting the image information into image data, for example, a CCD sensor, which will not be described in detail. The image reading section 5 converts reflected light into an image signal through the CCD sensor. The reflected light is obtained by irradiating light from an illuminating apparatus onto the original set into the original table 5a.

Moreover, the image reading section 5 integrally has an automatic document feeder (ADF) 7 for discharging a read original from a reading position to a discharging position and guiding the next original to the reading position after formation of an image output or taking of image information (hereinafter referred to as a read) is ended when the original is a sheet. In place of the ADF 7, a general original cover may be used. Furthermore, the CCD sensor of the image reading section 5 may be positioned in an optional position in a delivery path through which the original is delivered in the ADF 7 independently of the original table 5a. The CCD sensor placed in an optional position in the delivery path through which the original is delivered independently of the original table 5a reads, as image data, image information included in the original during the delivery without the original positioned on the original table 5a.

An instruction input section for giving an instruction for starting image formation in the image forming section 1 and starting to read image information of the original through the image reading section 5, that is, a control panel (an operating section) 9 is placed in a strut 9a (fixed to the image forming section 1) and a swing arm 9b in a corner at the left or right side behind the image reading section 5 or the like.

The image forming section 1 includes first to fourth photoconductive drums 11a to 11d for holding latent images, developing devices 13a to 13d for supplying developers, that is, toners to the latent images held by the photoconductive drums 11a to 11d and carrying out development, a transfer belt 15 for holding toner images held by the photoconductive drums 11a to 11d in order, cleaners 17a to 17d for removing the toner remaining on the photoconductive drums 11a to 11d from the individual photoconductive drums 11a to 11d, a transfer device 19 for transferring the toner image held by the transfer belt 15 onto plain paper or a sheet-like transfer medium (hereinafter referred to as a sheet material) such as an OHP sheet to be a transparent resin sheet, a fuser device 21 for fixing the toner image transferred to the sheet material by the transfer device 19 onto the sheet material, and an exposing device 23 for forming latent images on the photoconductive drums 11a to 11d and the like.

The first to fourth developing devices 13a to 13d store toners having optional colors of Y (yellow), M (magenta), C (cyan) and Bk (black) which are used for obtaining a color image by a subtractive process and visualize a latent image held by each of the photoconductive drums 11a to 11d in any one of the colors Y, M, C and Bk. The respective colors are determined in predetermined order corresponding to an image forming process or a characteristic of the toner.

The transfer belt 15 holds the toner images having the respective colors which are formed by the first to fourth photoconductive drums 11a to 11d and the corresponding developing devices 13a to 13d in order (of the formation of the toner images).

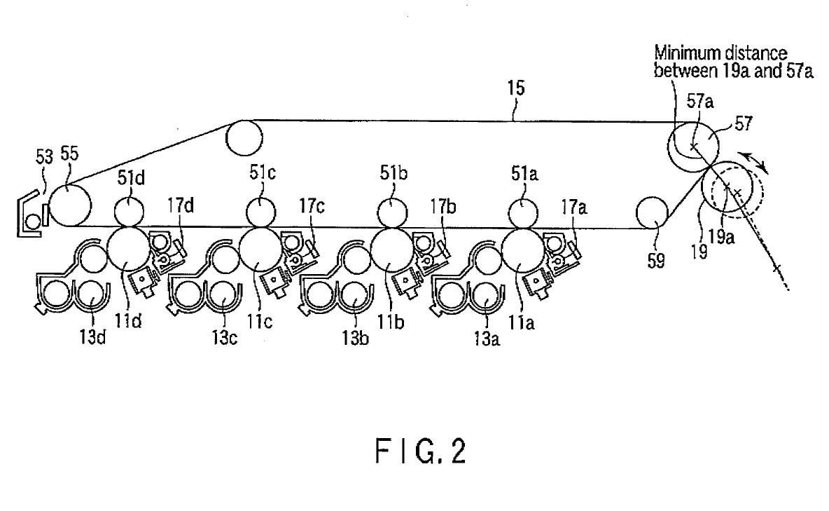

As explained later with reference to FIG. 2, the transfer belt 15 receives pressure from each of a belt opposed member 51 configured to set pressure between the photoconductive drums 11a to 11d and the transfer belt 15 of the image forming section 1, a belt cleaner opposed member 55 configured to set pressure applied by a belt cleaner 53 for cleaning the surface of the transfer belt 15, and a transfer opposed member 57 configured to set pressure applied when the sheet material is brought into contact with the transfer belt 15 by the pressure from the transfer device 19.

The paper supply section 3 supplies, at predetermined timing, the sheet material to be used for transferring the toner image by the transfer device 19.

Cassettes positioned in a plurality of cassette slots 31, which will not be described in detail, store sheet materials having optional sizes. Depending on an image forming operation which will not be described in detail, a pickup roller 33 takes the sheet material out of the corresponding cassette. The size of the sheet material corresponds to the size of the image of the developer formed by the image forming section 1.

A separating mechanism 35 prevents at least two sheet materials from being taken out of the cassette by the pickup roller 33.

A plurality of delivery rollers 37 feed the sheet material separated to be one sheet by the separating mechanism 35 toward an aligning roller 39.

The aligning roller 39 feeds the sheet material to a transfer position in which the transfer device 19 and the transfer belt 15 come into contact with each other in timing for transferring the image of the developer from the transfer belt 15 by the transfer device 19.

The fuser device 21 fixes the image of the developer (toner) corresponding to the image information onto the sheet material, that is, the output image (hard copy or print out) and feeds the output image to a stock section 47 positioned in a space between the image reading section 5 and the image forming section 1.

The transfer device 19 is positioned in an automatic duplex unit (ADU) 41 for replacing both sides of the sheet material, that is, the output image (hard copy or print out) which has the toner image fixed thereto by the fuser device 21. A bypass tray 81 is attached to the ADU 41.

The ADU 41 moves to a side (the right side) with respect to the image forming section 1 when the sheet material is jammed between the delivery roller 37 (a final one) and the aligning roller 39 or between the aligning roller 39 and the fuser device 21, that is, in the transfer device 19 or the fuser device 21. The ADU 41 integrally has a cleaner 43 for cleaning the transfer device 19.

A media sensor 45, arranged in a path between the delivery roller 37 and the aligning roller 39, detects the thickness of the sheet material conveyed to the aligning roller 39. The media sensor 45 useable an optical type benefit of priority from: U.S. patent application Ser. No. 12/197,880 filed on Aug. 25, 2008 and No. 12/199,424 filed on Aug. 27, 2008 and/or a shift of thickness detecting roller type benefit of priority from: U.S. Provisional Application No. 61/043,801 filed on Apr. 10, 2008, each of which are incorporated.

FIG. 2 shows a transfer section of an imaging section in the MFP shown in FIG. 1.

A bend of a belt surface of the transfer belt 15 is a fixed amount related to tension from at least one tension device. The belt opposed member 51, the belt cleaner opposed member 55, and the transfer opposed member 57 are, for example, roller members. The belt opposed member 51 provides the transfer belt 15 (and the photoconductive drums 11a to 11d) with a transfer voltage (an electrostatic field). The transfer device 19 applies, when the sheet material moves between the transfer device 19 and the transfer belt 15, pressure for transfer to the sheet material (and the transfer belt 15). The transfer device 19 provides the sheet material (and the transfer belt 15) with a transfer voltage (an electrostatic field).

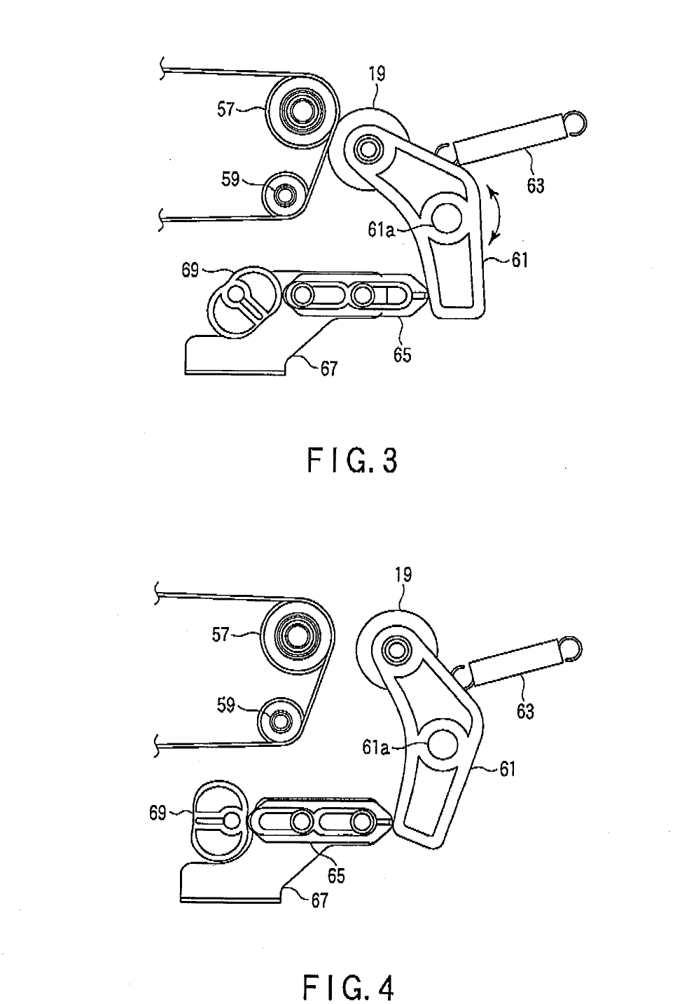

FIGS. 3 and 4 show the operation (the position) of the transfer device for moving a toner image held by the transfer belt onto the sheet material.

The transfer device 19 is held by a supporting member 61 having a fulcrum 61a. During non-transfer (non-image formation), as shown in FIG. 4, a spring 63 applies a load to the supporting member 61 such that the supporting member 61 is located on a side on which the transfer device 19 (supported by the supporting member 61) is not in contact with the transfer opposed member 57 and the transfer belt 15 located on the outer circumference of the transfer opposed member 57 (a separated state or a non-pressed state). During image formation (during a printing sequence), as shown in FIG. 2, the supporting member 61 turns around the fulcrum 61a such that the transfer device 19 (supported by the supporting member 61) is located in a position where the transfer device 19 is in contact with the transfer belt 15 and the transfer opposed member 57 located on the inner side of the transfer belt 15 at a transfer pressure or pressure for the sheet material. Image formation is permitted in a state in which the transfer device 19 supported by the supporting member 61 moves to a position where a segment connecting a center axis 57a of the transfer opposed member 57 and a center axis 19a of the transfer device 19 is a straight line (a distance between the two center axes is the minimum) or a state in which the transfer device 19 moves to a position where the transfer device 19 turns further to an auxiliary member 59 side, which applies tension to the transfer belt 15 in cooperation with the transfer opposed member 57, than the position where the distance between the two center axes is the minimum.

A pusher 65 linearly moves to apply a propulsion pressure (pressure for turning the supporting member) to the supporting member 61.

The propulsion pressure (i.e., a movement amount of the pusher 65) permits the transfer device 19 supported by the supporting member 61 to come into contact with the transfer belt 15 (a contact state). A guide (a pusher supporting member) 67 guides the pusher 65 to linearly (reciprocatingly) move. For example, when the pusher 65 has a long hole (parallel grooves) extending in one direction, the guide 67 is formed in a pin shape. For example, when the pusher 65 is a projection (a pin or a rib), the guide 67 may be formed in a parallel groove or rail shape.

A cam 69 sets the movement amount of the pusher 65 according to rotation of the cam 69.

A transfer pressure acting on the sheet material moving between the transfer device 19 and the transfer belt 15 changes according to the movement amount of the pusher 65. In other words, the transfer pressure acting on the sheet material can be arbitrarily set between the transfer device 19 and the transfer belt 15 by changing the movement amount of the pusher 65.

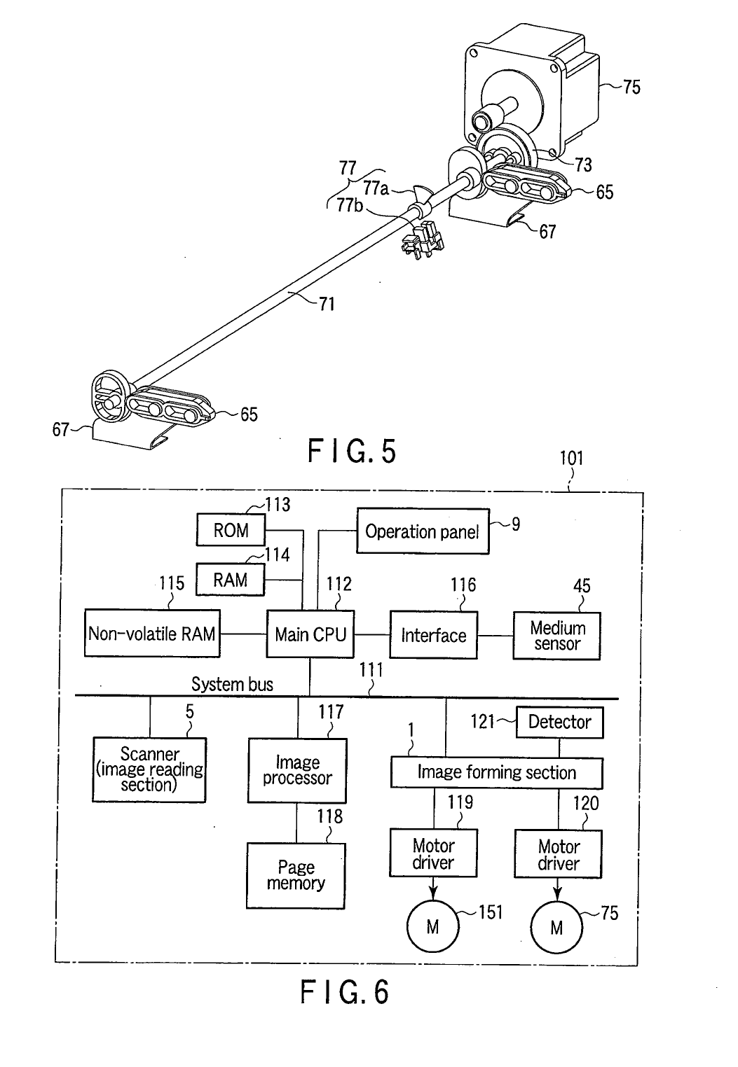

FIG. 5 shows an example of a mechanism configured to move (reciprocatingly move) the pusher shown in FIGS. 3 and 4.

The transfer device 19 supported by the supporting member 61 is located in a position for providing the transfer pressure to the transfer belt 15 and the transfer opposed member 57 (the contact state) or a position in the non-pressed state (the separated state) according to the reciprocating movement of the pusher 65 by the rotation of the cam 69.

A shaft 71 supports the cam 69. The shaft 71 receives rotation of a stepping motor 75 via a gear 73. The stepping motor 75 rotates in a first direction and a second direction opposite to the first direction. A rotation sensor 77 including an actuator 77a held by the shaft 71 and a position detection sensor 77b for detecting presence or absence of the actuator 77a measures a rotation amount (a rotation angle) of the cam 69. Specifically, when the actuator 77a passes through the position detection sensor 77b, the magnitude or the polarity of a sensor signal output by the sensor 77b is switched. With this switching as a trigger, the rotation angle (a rotation position) of the cam 69 stops in a specified position.

The cam 69 and the actuator 77a are positioned with respect to the circumference of the shaft 71. This makes it possible to accurately set the movement amount given to the supporting member 61 by the pusher 65. Therefore, it is possible to accurately set the transfer pressure applied to the transfer belt 15 and the transfer opposed member 57 by the transfer device 19.

FIG. 6 shows a control system of the MFP illustrated in FIGS. 1 to 5.

The MFP (image forming apparatus) 101 includes a system bus line 111. The system bus line 111 connects a main control block, that is, a main CPU 112 for processing image information of an object to be outputted by an image forming section 1. The MFP 101 includes the scanner 5 and an image processor 117. The MFP 101 includes a motor driver 119 which provides electric pulse to rotate the stepping motor 151. A rotational angle of the stepping motor 151 is proportional to a number of the pulses. A rotation speed is in proportional to a number of the pulses and to control the moving speed of the transfer belt 15 rotates by the first roller 55. The image forming section 1 includes a motor driver 120 which provides electric pulse to rotate the stepping motor 75. A rotational angle of the stepping motor 75 is proportional to a number of the pulses. The main control block 112 connects an ROM (Read Only Memory) 113, an RAM (Random Access Memory) 114, and a non-volatile RAM 115 for storing a total number of times of image formation, a total operating (working) time or the like, an interface 116 for inputting an output of the media sensor 45 to the main control block 112, and the operation panel 9. The image processor 117 connects a page memory 118.

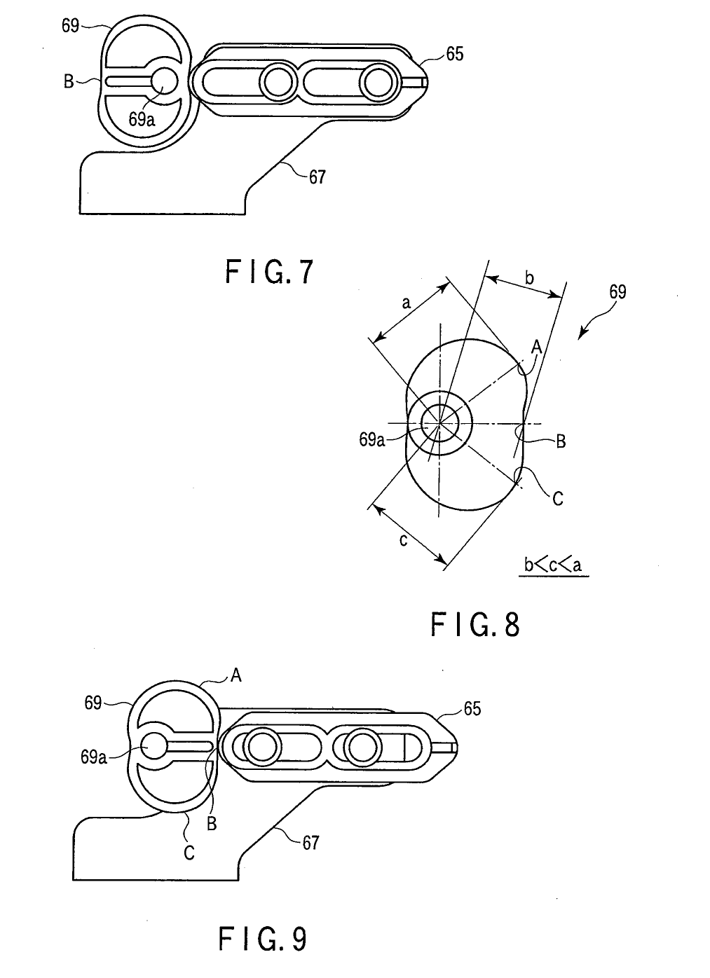

FIG. 7 shows the operation of the pusher 65 and the cam 69 schematically shown in FIGS. 3 and 4 in a state (of the cam 69) immediately before a sheet enters the transfer position where the supporting roller 57 and the transfer roller 19 are in contact with each other. FIG. 8 shows a state of the cam 69 viewed from a direction orthogonal to an axis of a shaft hole, i.e., a characteristic of a cam outer circumferential shape.

The outer circumference of the cam 69 is an oblong shape or an elliptical shape having at least one concave section “b”. An area of the pusher 65 in contact with the outer circumference of the cam 69 is a curved surface of a convex shape.

In the cam 69, a distance “a” from a shaft hole 69a to an outer circumference A section (a first convex section) is larger than a distance “c” from the shaft hole 69a to an outer circumference C section. The distance “c” from the shaft hole 69a to the outer circumference C section (a second convex section) is larger than a distance “b” from the shaft hole 69a to an outer circumference B (concave) section.

During the printing sequence, as shown in FIG. 3, the cam 69 pushes the pusher 65 in the horizontal direction, overcomes the load of the spring 63, and brings the transfer roller 19 into contact with the supporting roller 57.

At other timing, as shown in FIG. 4, an amount with which the cam 69 pushes in the pusher 65 is not large enough for bringing the transfer roller 19 into contact with the supporting roller 57 and spaces the transfer roller 19 away from the supporting roller 57.

In a state in which the sheet is present in a secondary transfer position between the transfer roller 19 and the supporting roller 57 while the cam 69 is maintained in the position shown in FIG. 3, moving speed of the transfer belt 15 falls because of the thickness of the sheet. In this case, in the transfer position where the transfer belt 15 and pre-transfer rollers 51a to 51d are in contact with each other, positions of toners moving to the transfer belt 15 fluctuate (the toners move at an interval different from an original interval of movement conforming to a space between the pre-transfer rollers 51a to 51d). In this case, a color drift may occur because of superimposition of the toners of four colors.

The occurrence of a color drift can be suppressed by depressing a transfer pressure in the secondary transfer position taking into account the presence of the sheet in the secondary transfer position during actual printing. However, it is undesirable to reduce, within an image area, the transfer pressure in the secondary transfer position.

Therefore, as shown in FIG. 12, it is desirable to maintain the transfer pressure, which is applied to the transfer belt 15 and the supporting roller 57 by the transfer roller 19, at first magnitude for a predetermined time immediately before the leading end of the sheet having a thickness equal to or smaller than a threshold enters the transfer area and after the trailing end of the sheet exits the transfer area. The thickness as the threshold is, for example, the thickness of a sheet, weight per 1 m² of which is 105 g.

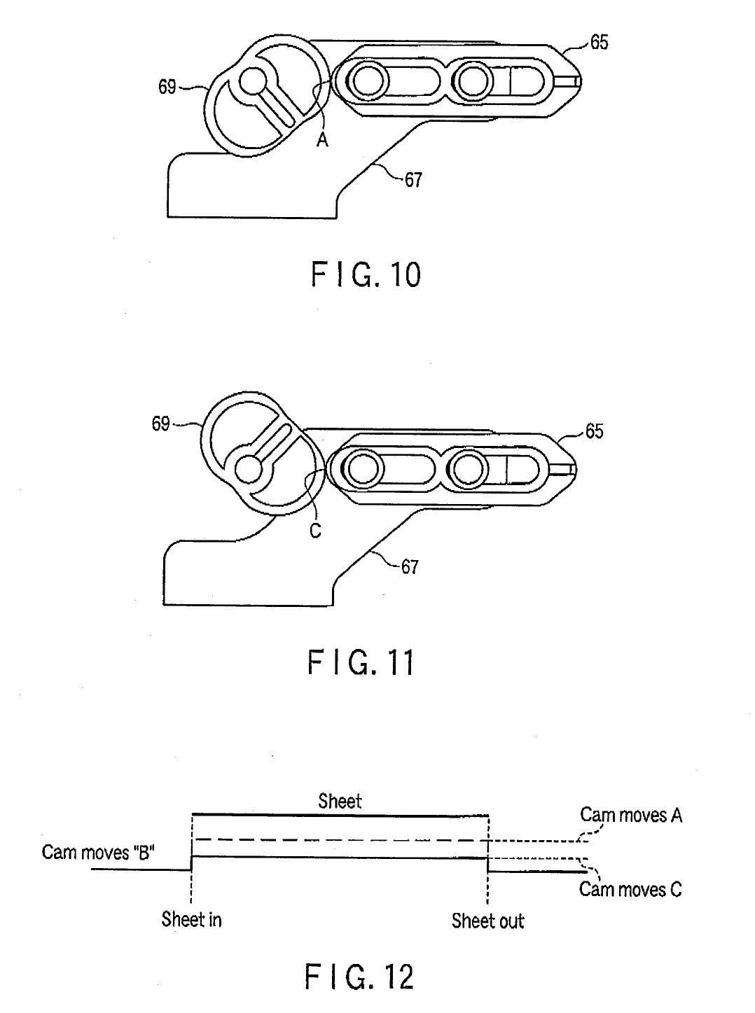

During (actual) image formation when the sheet is located in the transfer position where the transfer roller 19 and the supporting roller 57 are in contact with each other, load fluctuation occurs when the sheet passes the transfer position. Therefore, as shown in FIG. 11, the transfer pressure in the transfer position is set to the first pressure (magnitude) in a cam position [C] of the cam 69 shown in FIG. 8. Concerning thick paper having a thickness exceeding the threshold, as shown in FIG. 10, the transfer pressure in the transfer position is set to second pressure (magnitude) larger (higher) than the first pressure in a cam position [A] of the cam 69 shown in FIG. B. It is possible to suppress a color drift from occurring irrespective of the thickness of a sheet by setting the two transfer pressures. In each of the cam positions [A] and [C], a different load is assumed according to the thickness of a sheet. During the actual image formation, the cam position [B] is used. The cam positions [A] and [C] are useful for calculating a speed fluctuation amount of the transfer belt 15 in a state close to an actual, printing condition.

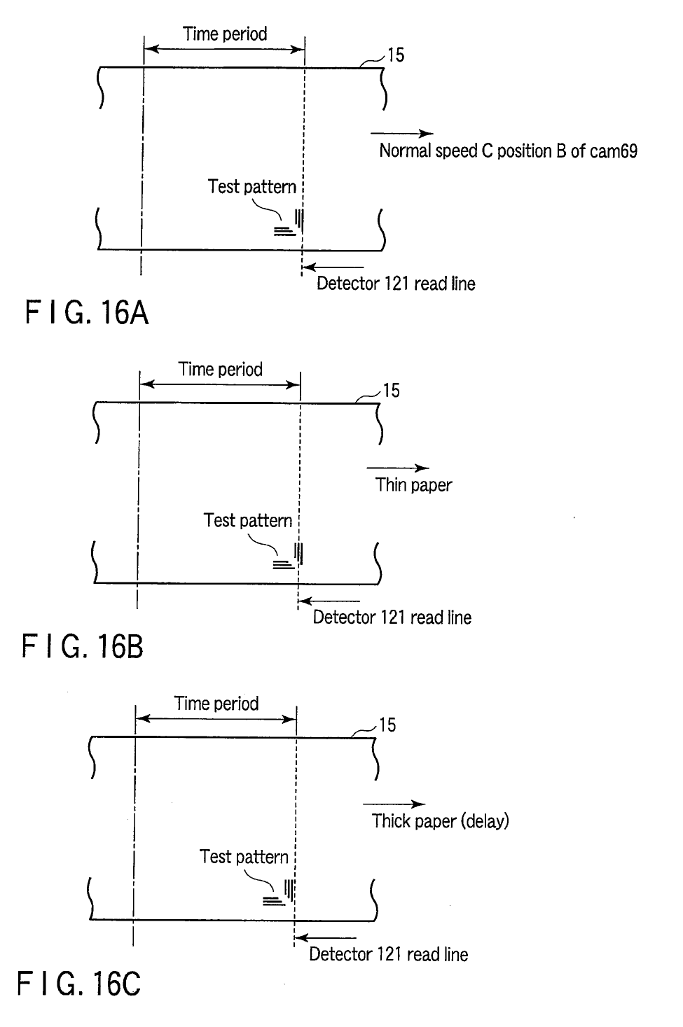

A speed fluctuation amount of the transfer belt 15 at the time when the sheet (or the thick paper) is located in the transfer area (the transfer position) can be calculated by comparing, during alignment control performed by using the first or second transfer pressure, the speed of the transfer belt 15 obtained by assuming a position of a load during actual printing to which the cam position [B] of the cam 69 shown in FIG. 8 is applied and a passing time of a test pattern formed on the transfer belt 15 shown in FIGS. 16A, 16B, and 16C according to the cam position [A (the transfer pressure of the second magnitude obtained by assuming the thick paper) or [C (the transfer pressure of the first magnitude obtained by assuming paper having a thickness smaller than the thickness of the thick paper)].

In other words, as shown in FIGS. 16A, 16B, and 16C, a speed fluctuation amount of the transfer belt 15 (a sheet) can be calculated by detecting, with a detector 121, during alignment control for the cam 69, moving speed of the transfer belt 15 (the number revolutions of the motor 151) in a position of “b” (time of contact between the supporting roller 57 and the transfer roller 19) and a passing time of a test pattern formed on the transfer belt 15 when pressure provided by “a” of the cam 69 or “c” of the cam 69 is used and comparing the moving speed and the passing time. It is possible to surely suppress a color drift from occurring according to the thickness of a sheet by changing, during an actual image output operation, the detected speed fluctuation amount in conjunction with control of the rotation of the cam 69, i.e., the pressure between the supporting roller 57 and the transfer roller 19.

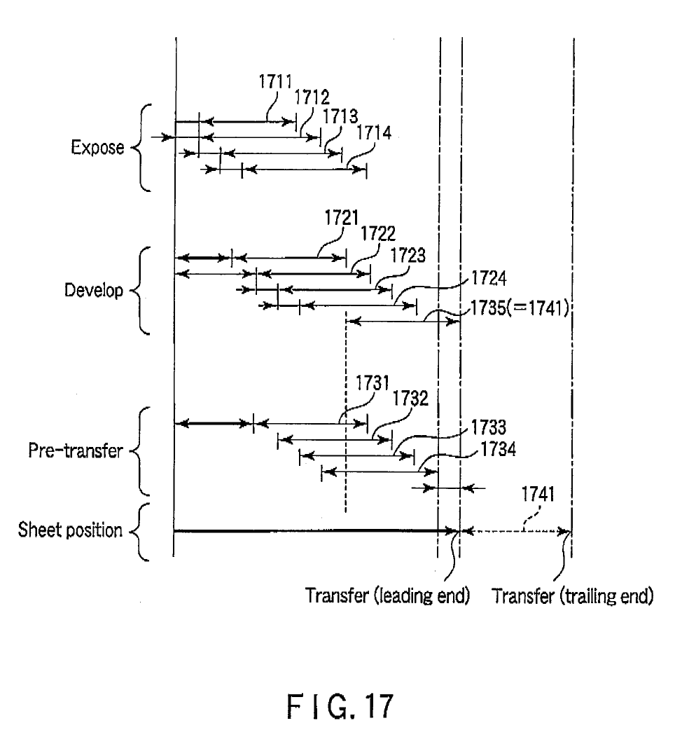

More specifically, among exposure of images of first to fourth color components on the photoconductive drums 11a to 11d (periods 1711 to 1714), development of the images of the first to fourth color components held by the photoconductive drums 11a to 11d (visualization, periods 1721 to 1724), transfer of the first to fourth color images held by the photoconductive drums 11a to 11d (pre-transfer in which superimposition of the color images occurs, periods 1731 to 1734) shown in FIG. 17, the periods of pre-transfer 1731 to 1734 of arbitrary color images overlap a period of transfer of a pre-transferred image onto a sheet (transfer, 1741) in the transfer position, i.e., the position where the supporting roller 57 and the transfer roller 19 are in contact with each other. In other words, when a period required by the transfer 1741 is represented as period 1735 and superimposed on the periods of pre-transfer 1731 to 1734, the period of pre-transfer 1731 to 1734 in all the colors overlap the period 1735. For example, in the period of pre-transfer 1731 of an a first color image, a portion closer to the rear end of the image overlaps start timing of the period 1735. In the periods of pre-transfer 1732 and 1733 of the second and third color images, portions near the centers of the images overlap the start timing. In the period of pre-transfer 1734 of a fourth color image, a portion closer to the front end of the image overlaps the start timing.

Since the period 1741 (transfer) is a cause of a speed change of the transfer belt 15, it is possible to prevent a color drift of the color images from occurring in the periods of pre-transfer 1731 to 1734 by, when a pre-transferred image is transferred onto a sheet, predicting that the speed change of the transfer belt 15 explained with reference to FIGS. 16A, 16B, and 16C occurs and changing a control amount of the cam 69 shown in FIG. 12 on the basis of the thickness of the sheet.

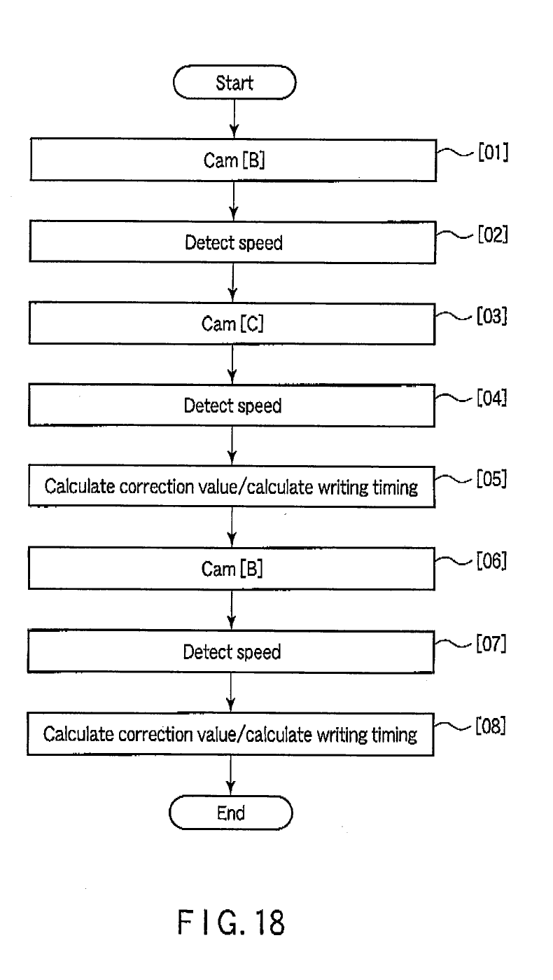

In an actual operation (image formation of the color components, movement of a sheet, and speed control of the transfer belt), as indicated by a flowchart of an adjustment mode shown in FIG. 18, in cam alignment (a rotation amount of the motor 75) and image formation (start of writing by a laser) timing control (transfer belt speed adjustment), a main CPU 112 of the MFP 101 sets a rotation angle of the motor 75 such that the cam position [B] of the cam 69 acts on the pusher 65 [01]. The main CPU 112 detects the speed of the transfer belt 15 [02].

The main CPU 112 sets the rotation angle of the motor 75 such that the cam position [C] of the cam 69 acts on the pusher 65 [03]. The main CPU 112 defines a state in which the transfer pressure in the transfer position where the transfer roller 19 and the supporting roller 57 are in contact with each other is equivalent to the first magnitude and detects the speed of the transfer belt 15 [04].

The main CPU 112 calculates a correction value X (a first correction value) of the number of revolutions of the motor 151 corresponding to a detected speed difference and stores the correction value X in a memory (NVRAM) 115 [05]. The main CPU 112 may set, on the basis of the detected speed difference, timing when the exposing device 23 starts image formation (timing for starting writing by a laser beam).

The main CPU 112 sets the rotation angle of the motor 75 such that the cam position [A] of the cam 69 acts on the pusher 65 [06]. The main CPU 112 defines a state in which the transfer pressure in the transfer position where the transfer roller 19 and the supporting roller 57 are in contact with each other is equivalent to the second magnitude and detects the speed of the transfer belt 15 [07].

The main CPU 112 calculates a correction value Y (a second correction value, Y>X) of the number of revolutions of the motor 151 corresponding to a detected speed difference and stores the correction value Y in the memory (NVRAM) 115 [08]. The main CPU 112 may set, on the basis of the detected speed difference, timing when the exposing device 23 starts image formation (timing for starting writing by a laser beam).

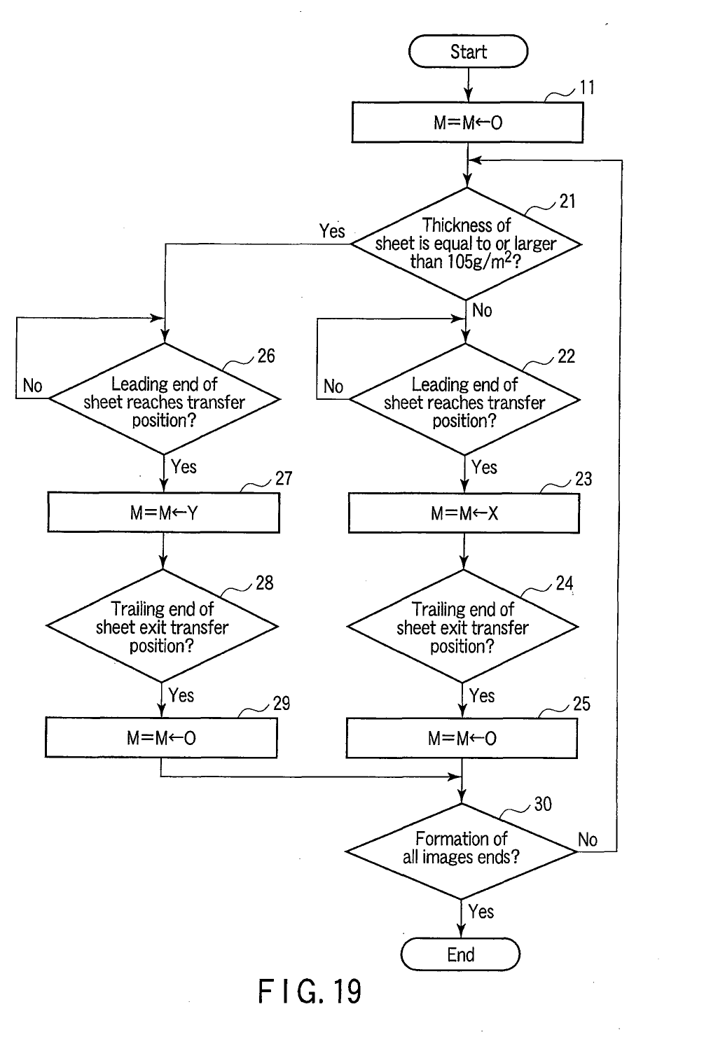

During the image formation, as shown in FIG. 19, the main CPU 112 sets a correction value M to “M=M←0 (no correction)” at a point when the start of the image formation is instructed [11]. The main CPU 112 checks, according to an output of the media sensor 45, the thickness of a sheet used for an image output [21].

If the thickness of the sheet is equal to or smaller than a threshold [NO in 21], the main CPU 112 detects that the leading end of the sheet reaches the transfer position [YES in 22] and sets the correction value M to “M=M←X (the first correction value)” [23].

The main CPU 112 sets, at timing when the trailing end of the sheet passes the transfer position [YES in 24], the correction value M to “M=M←0” according to an input sheet size of a sheet size specified by a size detecting function [25].

When the thickness of the sheet exceeds the threshold [YES in 21], the main CPU 112 detects that the leading end of the sheet reaches the transfer position [YES in 26] and set the correction value M to “M=M←Y (the second correction value)” [27].

The main CPU 112 sets, at timing when the trailing end of the sheet passes the transfer position [YES in 28], the correction value M to “M=M←0” according to an input sheet size of a sheet size specified by the size detecting function [29].

The main CPU 112 repeats [21] to [25] and [26] to [29] until the end of the image formation [YES in 30]. When the thickness of the sheet is equal to or smaller than the threshold, the main CPU 112 may set the correction value M to “M=M←0 (no correction)”.

The media sensor 45 detects the thickness of the sheet. However, for example, when an instruction of a “thick paper mode” is input from the control panel (the operating section) 9, the mode is given priority.

In this way, it is possible to perform image formation in which a color drift does not occur because of speed fluctuation of the transfer belt 15 that could occur when the sheet reaches the transfer position (the speed fluctuation is sensed as a color drift) in relation to the thickness of the sheet.

The control of the speed of the transfer belt 15 is started at timing when the sheet reaches the transfer position during the actual printing operation. However, for example, the speed of the transfer belt 15 can also be controlled by changing the magnitude of an excitation current (increasing the magnitude (the number of pulses) of the excitation current to maintain speed) such that the torque of the motor 151 does not fall. When the sheet reaches the transfer position, since fluctuation in the speed of the transfer belt 15 is also related to the thickness of the sheet, the speed control and the control of writing by a laser beam can be limitedly applied during image formation on the thick paper.

In adjusting the position of the start of writing by a laser beam (timing of the start of the image formation), expecting that the speed of the transfer belt 15 fluctuates (delays) when the thick paper reaches the transfer position, the main CPU 112 stops writing of an image by the laser beam (delays the writing) by the number of lines in a main scanning direction equivalent to the delay. The delay in the writing is realized by, for example, delaying timing for reading out image data from the page memory 118 or inserting blank lines equivalent to the delay (the number of lines in the main scanning direction) into image data stored by a page memory 118. In this case, a delay amount is set for each of the colors.

An example of the transfer pressure given to the transfer belt 15 and the supporting roller 57 by the transfer roller 19 is explained below.

In the non-pressed state (the separated state), in the cam 69, as shown in FIG. 7, the concave section (the B section shown in FIG. 8) is located on the opposite side of the pusher 65 with respect to the shaft hole 69a. In other words, the transfer roller 19 does not apply pressure to the transfer belt 15 and the supporting roller 57.

When image formation is instructed, during a period until the leading end of a sheet moves to the transfer area where the transfer roller 19 and the transfer belt 15 and supporting roller 57 are in contact with each other (during toner image non-transfer), the cam 69 rotates according to the rotation of the stepping motor 75 such that the concave section (the B section) is located on the pusher 65 side with respect to the shaft hole 69a as shown in FIG. 9. Therefore, pressure of the contact of the transfer roller 19 and the transfer belt 15 in the transfer area during toner image non-transfer is set to pressure of contact of the outer circumference B section and the pusher 65 during image transfer and maintained.

On the other hand, during image formation on the thick paper having a thickness larger than the threshold, the speed of the transfer belt 15 (the number of revolutions of the motor 151) is changed (increased) according to time when the thick paper enters the transfer area. Alternatively, the number of pulses (to be supplied) or a driving voltage is set (increased) according to the control of the number of pulses such that the torque of the motor 151 increases.

This makes it possible to prevent speed fluctuation of the transfer belt 15 that could occur when the thick paper enters the transfer position where the supporting roller 57 and the transfer roller 19 are in contact with each other. In particular, this is useful during color image formation for superimposing the four color images.

In this way, loads on the transfer roller 19 and the transfer belt 15 (and the supporting roller 57) fluctuate according to the thickness of the sheet. Therefore, alignment is performed in the position of “c” by assuming plain paper (having a thickness equal to or smaller than the threshold) (see FIG. 11). Alignment is performed in the position of “a” by assuming the thick paper (see FIG. 9). This makes it possible to absorb speed fluctuation during image output to the thick paper in which a color drift often occurs compared with image output to the plain paper. The plain paper has, for example, a thickness giving a weight per 1 m² equal to or smaller than 105 g. The thick paper has, for example, a thickness giving a weight per 1 m² exceeding 105 g.

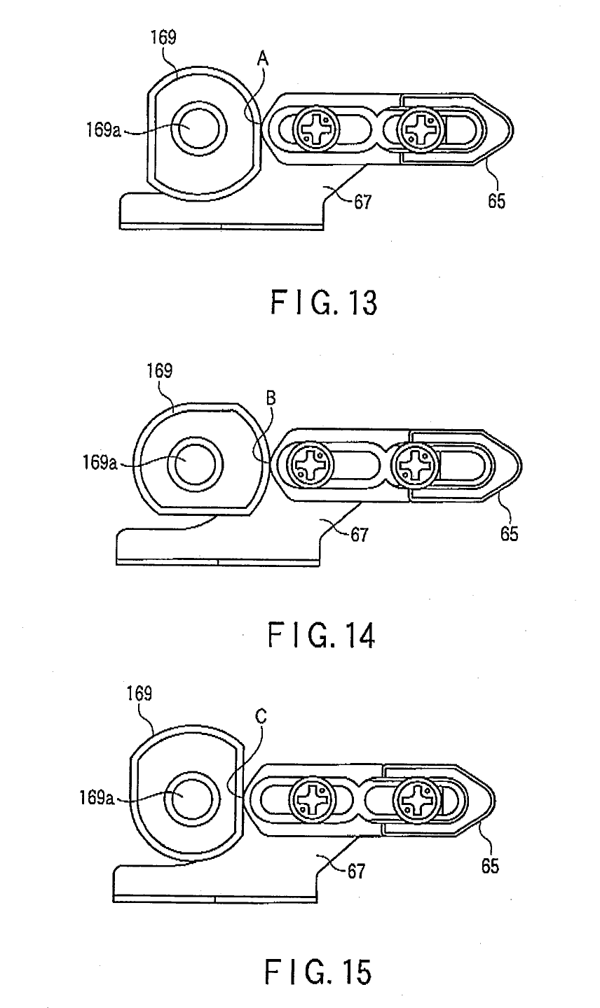

It is possible to obtain functions same as those of the cam 69 explained with reference to FIG. 8 using a cam 169 in which all the cam positions shown in FIGS. 13 to 15 are convex or plane (not having a concave section) (B (FIG. 14>A (FIG. 13)>C (FIG. 15)). When the cam positions do not have a concave section, a degree of freedom of the shape of the pusher 65 is improved. For example, compared with the pusher 65 shown in FIGS. 3, 4, 7, and 9 to 11, an area in contact with the cam 169 can be increased and a characteristic against abrasion is improved.

According to the embodiment explained above, it is possible to prevent a situation in which the speed of the transfer belt 15 changes because of the thickness of a sheet and a color drift occurs during color image output.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer comprising:
an image carrier configured to move a first color image and a second color image layered each other to a sheet in a transfer position; and
a controller configured to change speed of forming the first color image and the second color image from a first speed to a second speed higher than the first speed if the thickness of the sheet exceeds a threshold, the first speed including speed obtained by correcting fluctuation in the speed due to the thickness of the sheet with respect to the second speed.

2. The printer of claim 1, wherein the controller changes the speed to the first speed when a media sensor detects that the thickness of the sheet exceeds the threshold.

3. The printer of claim 1, wherein the controller changes the speed to the first speed when the controller maintains the thickness of the sheet exceeding the threshold according to an instruction input.

4. The printer of claim 2, further comprising:
a pre-image carrier configured to hold an image to form the first color image and the second color image; and
a pre-transfer member configured to pre-transfer the first color image and the second color image from the pre-image carrier to the image carrier.

5. The printer of claim 4, further comprising a transfer member configured to transfer the overlapping the first and second color images onto the sheet in the transfer position.

6. The printer of claim 1, wherein the first speed is prepared according to pressure applied to the image carrier in the transfer position according to the thickness of the sheet.

7. The printer of claim 6, wherein the controller changes the speed to the first speed when a media sensor detects that the thickness of the sheet exceeds the threshold.

8. The printer of claim 6, wherein the controller changes the speed to the first speed when the controller maintains the thickness of the sheet exceeding the threshold according to an instruction input.

9. The printer of claim 7, further comprising:
a pre-image carrier configured to hold an image to form the first color image and the second color image; and
a pre-transfer member configured to pre-transfer the first color image and the second color image from the pre-image carrier to the image carrier.

10. The printer of claim 9, further comprising a transfer member configured to transfer the overlapping the first color image and the second color image onto the sheet in the transfer position.

11. The printer of claim 6, wherein the first speed is prepared according to pressure applied to the image carrier in the transfer position according to the thickness of the sheet.

12. An image forming apparatus comprising:
a sheet feeder configured to feed a sheet;
a media sensor configured to determine the thickness of the sheet;
an image carrier configured to move a first color image and a second color image layered each other to a sheet in a transfer position; and
a controller configured to change speed of forming the first color image and the second color image from a first speed to a second speed higher than the first speed if the thickness of the sheet exceeds a threshold, the first speed including speed obtained by correcting fluctuation in the speed due to the thickness of the sheet with respect to the second speed.

13. The apparatus of claim 12, further comprising:
a pre-image carrier configured to hold an image to form the first color image and the second color image; and
a pre-transfer member configured to pre-transfer the first color image and the second color image from the pre-image carrier to the image carrier.

14. The apparatus of claim 13, further comprising a transfer member configured to transfer the overlapping the first color image and the second color image onto the sheet in the transfer position.

15. The apparatus of claim 12, wherein the first speed is prepared according to pressure applied to the image carrier in the transfer position according to the thickness of the sheet determined by the media sensor.

16. The apparatus of claim 15, wherein the controller changes the speed to the first speed when the media sensor detects that the thickness of the sheet exceeds the threshold.

17. A method for forming an image comprising:
feeding sheets one by one;
making an a first color image and a second color image on an image carrier in a state in which the images overlap each other;
moving the overlapping the first color image and the second color image to a sheet in a transfer position; and
changing speed of forming the first color image and the second color image from a first speed to a second speed higher than the first speed when the thickness of the sheet exceeds a threshold, the first speed including speed obtained by correcting fluctuation in the speed due to the thickness of the sheet with respect to the second speed.

18. The method of claim 17, wherein the changing includes changing the speed to the first speed when a media sensor detects that the thickness of the sheet exceeds the threshold.

19. The method of claim 17, wherein the changing includes changing the speed to the first speed when the thickness of the sheet exceeding the threshold is maintained according to an instruction input.

20. The method of claim 17, wherein the first speed is prepared according to pressure applied to the image carrier in the transfer position according to the thickness of the sheet.
